(19) United States
(12) Patent Application Publication
(10) Pub. No.: US 2003/0069974 A1
(43) Pub. Date: Apr. 10, 2003

(54) Method and apparatus for load balancing web servers and virtual web servers

(76) Inventors: Tommy Lu, Grand Prairie, TX (US); Timothy Mai, Sugar Land, TX (US)

Correspondence Address: James A. Harrison, P.O. Box 670007, Dallas, TX, 75367, US

(21) Appl. No.: 10/266,970

(22) Filed: Oct. 7, 2002

Related U.S. Application Data
(60) Provisional application No. 60/327,648, filed on Oct. 8, 2001.
(60) Provisional application No. 60/327,647, filed on Oct. 8, 2001.

(51) Int. Cl. G06F 15/173

(52) U.S. Cl. 709/226; 709/105

(57) ABSTRACT

The present invention provides a network and network elements therein that facilitate automatic, fast and efficient provisioning and load balancing of network resources to activate a requested service. Accordingly, the advantages of the present inventive network and the solutions to the aforementioned problems are one and the same: the provisioning agent receives network condition information from a service manager integrator (SMI) to determine if software loads require redistribution and reassignment from one provisioning agent to another. In one embodiment, the consumer is able to specify a performance value that prompts redistribution of software loads to achieve compliant load balancing.

### CROSS-REFERENCE TO RELATED APPLICATION

This application claims priority to Provisional Patent Application having a serial No. of 60/327,648 and filing date of Oct. 8, 2001 and Provisional Patent Application having a serial No. of 60/327,647 and filing date of Oct. 8, 2001. This application is related to the following Regular Utility Patent Application that is being filed herewith on today's date, said application having the title of Method and Apparatus for Dynamic Provisioning Over a World Wide Web and is incorporated herein by reference.

### BACKGROUND

1. Technical Field

The present invention relates to computer networks and, more specifically, to provisioning services and allocating web server hosting.

2. Related Art

Whenever an individual or organization seeks to acquire new Internet access services or hosting services, a procedure is followed which includes manual entry of data. For example, typical web service providers and, more particularly, service providers of web hosting services, require a customer to select a subscribed package that is offered and advertised on web sites. The selected package will typically include parameters that define traffic logs, banner exchanges, and the need for secure shopping carts and inventory control.

To actually establish and provision this request, the selected parameters must be manually entered into various systems prior to the requested services becoming operational. Because manual processes are included, provisioning errors often occur. Moreover, even if the selected parameters are entered properly, a certain level of delay is always experienced.

For example, as a part of the provisioning process, user accounts must be established within the billing software. Additionally, the actual required services must be activated and established on one or more servers that provide some level of support for the required service. And finally, the mere raw resources to support the new service must be dedicated to the service. For example, memory and communication ports that will facilitate the desired bandwidth capability for the customer must be allocated in advance.

The types of entries that must be made in the individual servers that provide each of the aforementioned functions must be made and then activated. For example, user data must be entered into a billing system. To do so, a service provider must connect to the billing system, log in and create the account. Thereafter, the actual server that is to host the new customer must also be accessed to create the account there within. Thus, once again, the service provider must log in to the actual server, create the new customer accounts and then activate the accounts all prior to the customer having access to the subscribed service.

Another problem with present systems is one that is better viewed at the macro-network level. More specifically, network efficiencies are not realized because the distribution of resources with respect to the demand is often a function of marketing and advertising rather than intelligent resource management. Accordingly, one system may be operating at capacity while another system or server may be under utilized and may even be facing financial hardships as a result. What is needed, therefore, is a system that facilitates the activation of services and that further allocates resources in an efficient manner.

### SUMMARY OF THE INVENTION

The present invention provides a network and network elements therein that facilitate automatic, fast and efficient provisioning of network resources to activate a requested service. Additionally, the invention includes network elements that monitor network loading and redistribute software loads to maintain a balanced network within a specified degree of variation. Accordingly, the advantages of the present inventive network and the solutions to the aforementioned problems are one and the same: a consumer may purchase a network service and, as a result of the automatic provisioning processes described herein, may realize the activation of the purchased network service in a very short period of time.

To accomplish these advantageous features, a central integration server communicates with a consumer user terminal over a data packet network to provide service options and selections to the consumer. In the described embodiment, known graphical user interface display technologies and methods are utilized to interact with the consumer that is purchasing a service (e.g., web hosting). Upon receiving service option selections and customer account information, the central integration server distributes account information to a billing system. Additionally, it also distributes select service plan information to a provisioning server that makes provisioning decisions. Among other factors, the provisioning server evaluates what provisioning agents (servers that are to provide the requested service) have the capability to provide the requested service(s). The provisioning server also examines performance, reliability and redundancy requirements (if any) that are levied by the consumer. Finally, the provisioning server builds a list of candidate provisioning agents and selects among them in a manner that will lead to the greatest degree of load balancing among the plurality of provisioning agents.

As another aspect of the present invention, the provisioning agent further receives network condition information from a service manager integrator (SMI) to determine if software loads require redistribution and reassignment from one provisioning agent to another. For example, as a part of the service request, in one embodiment, the consumer is able to specify performance requirements that prompt redistribution of software loads to achieve better and compliant load balancing. That threshold values produced by the central integration server to the provisioning server.

In the described embodiment of the invention, software loading for each provisioning agent is measured in terms of remaining capacity. Thus, even if different provisioning agents have different capacities at the outset, the loads will be assigned so that, at any given time, the remaining capacity of the servers are approximately equal.

Other aspects of the present invention will become apparent with further reference to the drawings and specification, which follow.

### BRIEF DESCRIPTION OF THE DRAWINGS

A better understanding of the present invention can be obtained when the following detailed description of the preferred embodiment is considered with the following drawings, in which:

FIG. 1 is a functional block diagram that illustrates a prior art network;

FIG. 2 is a functional block diagram illustrating current implementations of dedicated virtual servers;

FIG. 3 is a functional block diagram illustrating a network formed according to one embodiment of the present invention;

FIG. 4 is a functional schematic block diagram that illustrates a central provisioning server formed according to one embodiment of the present invention;

FIG. 5 is a functional block diagram that illustrates one embodiment of the present invention;

FIG. 6 is a flowchart that illustrates a method for determining and allocating computer resources to provide requested service according to one embodiment of the present invention;

FIG. 7 is a flowchart that illustrates one method according to the present invention for load balancing;

FIG. 8 is a functional block diagram of a provisioning server formed according to one embodiment of the present invention; and

FIG. 9 is a flowchart that illustrates a method for automatically provisioning services for a user according to one embodiment of the present invention.

### DETAILED DESCRIPTION OF THE DRAWINGS

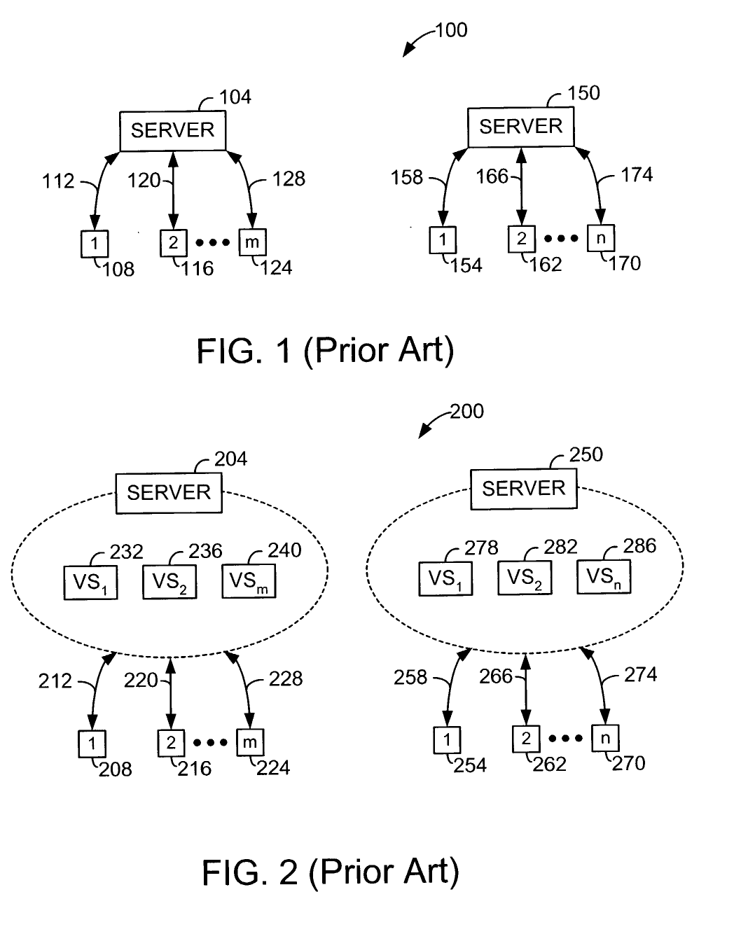

FIG. 1 is a functional block diagram that illustrates a prior art network. As may be seen, a network 100 includes a server 104 that is coupled to communicate with a user 108 by way of communication path 112, user 116 over communication path 120 and user 124 over communication path 128. Similarly, server 150 communicates with user 154 over communication path 158, user 162 over communication path 166 and user 170 over communication path 174. While not shown explicitly, it is understood that the communication paths probably include, and may include, a data packet network, such as the World Wide Web.

Additionally, each of these users establishes a relationship with a specific server 104 or 150 to provide (provision) its web hosting services. Thus, “m” users are connected to server 104, while “n” users are connected to server 150 for web hosting thereto or other web related services.

FIG. 2 is a functional block diagram illustrating current implementations of dedicated virtual servers. As may be seen, a network 200 comprises a provisioning server 204 that is coupled to communicate with user 208 over communication path 212, user 216 over communication path 220 and user 224 over communication path 228. Similarly, a provisioning server 250 communicates with user 254 over communication path 258, user 262 over communication path 266 and user 270 over communication path 274. One difference that is illustrated by the prior art system of FIG. 2 in relation to FIG. 1, however, is that each server includes logic that creates a plurality of virtual servers. More specifically, server 204 creates virtual servers 232, 236 and 240. Similarly, server 250 creates virtual servers 278, 282 and 286. Each virtual server 232, 236, 240, 278, 282 and 286 is bound to a specific IP address and host name. Thus, for example, when user 208 communicates with virtual server 232, it believes that it is communicating with a real and dedicated server, not a virtual server. There are many reasons for setting up an arrangement that includes a plurality of virtual servers for each server. One such advantage is that resources may be dedicated to a single customer that way.

One problem with the network 200 as shown in FIG. 2, however, is that virtual server resources may be allocated inefficiently for many different reasons. Thus, if server 204 reaches capacity, server 250 may well be operating at much lower levels. Accordingly, a user whose virtual server is being created or hosted by server 204 is more likely to experience transmission delays and other problems related to congestion than is a user of server 250. It would be advantageous, therefore, to provide load balancing between servers 204 and 250. Because, however, each virtual server is created upon its host server in a process that includes manual control and entry by an individual, each of the servers 204 and 250 tend to be operated in an independent manner relative to each other.

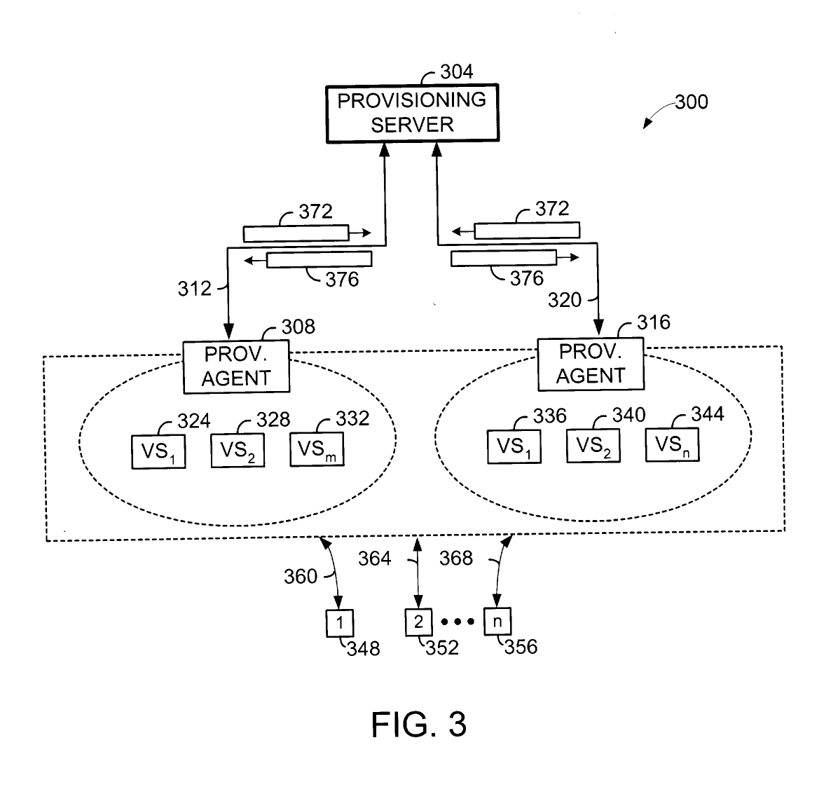

FIG. 3 is a functional block diagram illustrating a network formed according to one embodiment of the present invention. Referring now to FIG. 3, a provisioning server 304 is coupled to communicate with a plurality of servers (provisioning agents) that provide the actual resources for a virtual server or web service. As is shown in FIG. 3, provisioning server 304 is coupled to communicate with provisioning agent 308 over communication path 312 and provisioning agent 316 over communication path 320. Provisioning agent 308 defines a plurality of virtual servers 324, 328 and 332. Similarly, provisioning agent 316 defines a plurality of virtual servers 336, 340 and 344.

Users 348, 352 and 356 each has subscribed web hosting services provided by one of the previously mentioned virtual servers. As is shown, users 348, 352 and 356 communicate with the virtual servers over communication paths 360, 364 and 368, respectively. As is shown in FIG. 3, each of these users communicates over their respective communication path with one of the virtual servers created by provisioning agents 308 and 316. Which of the provisioning agents 308 or 316 actually host the virtual server 324, 328, 332, 336, 340 or 344 is transparent to the user and is controlled by provisioning server 304. A user 348, 352 or 356, when seeking to access its web page that is hosted by one of the virtual servers, uses an IP address that is mapped by a domain naming system (DNS) to an actual server that hosts the virtual server. Accordingly, the user 348, 352 or 356 is able to communicate with any one of a plurality of servers that actually provides the web hosting service for its virtual server in a manner that is transparent to the user.

One issue that is presented by the architecture and system of FIG. 3 is that of the assignment of virtual servers to actual servers. Provisioning server 304 determines which provisioning agent 308 or 316 will provide the actual hosting or will support the virtual server 324-344. As will be explained in greater detail, whenever a user 348-356 seeks to create an account for web hosting, for example, provisioning server 304 evaluates the capacities of each provisioning agent 308 or 316 with respect to parameters that relate to the loads of each server, as well as the available capabilities of each server in contrast to the required or desired services by the user 348-356 that is seeking to establish a new service.

For provisioning server 304 to make effective and efficient provisioning decisions, it must be aware of the loading and capacities of each provisioning agent 308 or 316. Accordingly, the network of FIG. 3, mainly network 300, is created to facilitate the generation of server status messages 372 that are periodically transmitted from provisioning agents 308 and 316 to provisioning server 304.

In one embodiment of the present invention, the signals 372 are merely transmitted on a periodic and defined basis. In another embodiment, signals 372 are transmitted upon request by provisioning server 304. The contents of signals 372 include available resources in terms of disk space, e-mail accounts and data transfer capabilities. Additionally, the signals 372 include a value that reflects an overall capacity or utilization of its internal resources. Thus, whenever provisioning server 304 receives a request for new service from a user 348-356, it evaluates the loading of each of the provisioning agents 308 and 316 as determined from the signals 372, to determine which server should host a virtual server that will satisfy the user's service request. In response to its analysis, provisioning server 304 generates command signals 376 to provisioning agent 308 or 316 to instruct it to establish the requested service for user 348-356.

Continuing to refer to FIG. 3, the provisioning agents 308 and 316 may also communicate with each by way of provisioning server 304 for many purposes, including transferring the information related to a virtual server from one provisioning agent 308 to the other provisioning agent 316 or vice versa. In the described embodiment of the invention, provisioning agents 308 and 316 communicate with each other by transmitting communication signals over communication path 312 and 320, which communication signals include Sun Microsystems Java Message Service (JMS) technology that is available with Sun Microsystems Java 2 Enterprise addition (J2EE). The server initiating the communication, in the described embodiment of the invention, sends a binary JMS message to the central or provisioning server 304 which, in turn, relates the message to provisioning agent 316. Provisioning agent 316 knows the format of the binary message and, as a result, may de-serialize the encapsulated object from the message's data stream. This allows the object to be used to transfer payload from provisioning agent 308 to provisioning agent 316. Additionally, with a publish/subscribe message broadcast framework, the provisioning server 304 can quickly automate and perform management paths on remote clients with minimal effort. Thus, in the present example, each of the signals 372 and 376 transmitted over communication paths 312 and 320 are binary JMS messages.

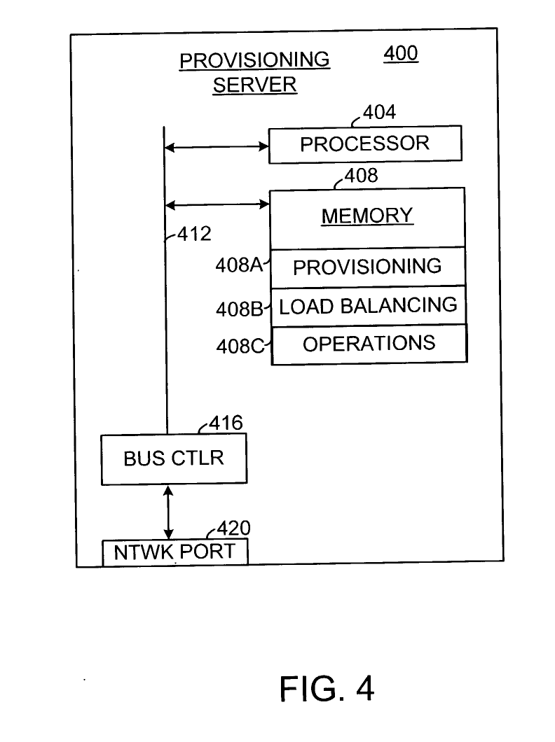

FIG. 4 is a functional schematic block diagram that illustrates a central provisioning server formed according to one embodiment of the present invention. A provisioning server 400 includes a processor 404 that communicates with a memory 408 by way of an internal bus 412. Internal bus 412 thus is coupled both to processor 404 and memory 408. Additionally, bus 412 is coupled to bus controller 416 that coordinates and controls the communications thereon according to the type of bus architecture that is implemented. For example, if bus 412 is a synchronized bus, then bus controller 416 generates the control signals and the clock pulses for communications thereon. Additionally, bus controller 416 serves to initiate and control as to when the various devices are allowed to communicate on the bus. In an embodiment wherein there are multiple bus masters present, then bus controller 416 further determines which bus master has access to the bus for a particular transaction.

Bus controller 416 further is coupled to a network port 420 that is for enabling provisioning server 400 to communicate with external devices. Memory 408 comprises computer instructions that define the operational logic of provisioning server 400. Accordingly, in addition to containing computer instructions that define routine operational logic, including communication protocols for communicating over bus 412, the computer instructions within memory 408 further define the logic for the various functions provided by provisioning server 400 as described herein. For example, the computer instructions define logic for establishing service for a customer, as well as for load balancing. Moreover, as has been described heretofore, in the described embodiment of the invention, the system communicates with the various servers using Sun Microsystems JMS technology. Accordingly, the computer instructions stored within memory 408 further define the operational logic to communicate in a manner that is compatible with each JMS technology. As is understood, processor 404 retrieves the computer instructions from memory 408 over bus 412 and executes them to implement the operational logic defined by the computer instructions.

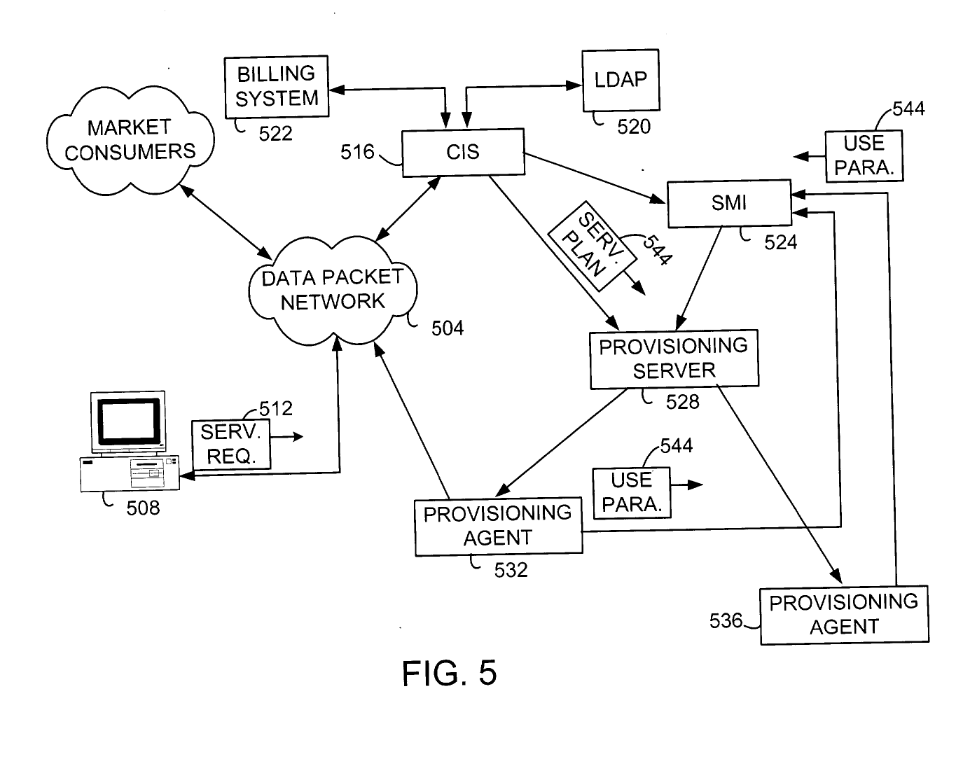

FIG. 5 is a functional block diagram that illustrates one embodiment of the present invention. A network 500 includes a data communication network 504 that is used to set up accounts and services between a user terminal 508 and a plurality of network elements of the present inventive system. While not shown specifically, it is understood that data communication network 504 may exist between any two devices that are not coupled directly. While many of the devices in FIG. 5 are shown to be coupled directly (for the sake of simplicity), the data packet network may exist there between.

Initially, a user terminal 508 communicates over data network 504 to generate a service request 512 that is transmitted to a central integration server (CIS) 516. CIS 516, generally speaking, redirects communication signals and selects what provisioning server is to provision services for user terminal 508. Additionally, CIS 516 generates graphical user interface screens that are transmitted to user terminal 508 to enable it to establish a requested service.

CIS 516 further is coupled to communicate with a lightweight directory access protocol server (LDAP) 520, as well as a billing system 522 and a service manager integrator (SMI) 524. In the described embodiment, billing system 522 comprises a billing database that is accessible by a provisioning server. Alternatively, the billing system 522 can comprise an actual billing server that communicates over the World Wide Web. LDAP 520 is for storing and providing subscriber profile information. SMI 524 is for managing network events. Specifically, it monitors all events and utilizes a rule engine to determine what notices and statistics should be generated to other systems. SMI 524 further is for monitoring network performance.

CIS 516 also is coupled to communicate with a provisioning server 528. Provisioning server 528 is formed to select and assign a provisioning agent to provide a requested service, to initiate and perform load balancing so that all provisioning agents are approximately equally balanced load-wise, and to support IP and DNS management. Within this context, SMI 524 executes its rule engines to determine when to generate usage statistics and network conditions to one or more provisioning servers such as provisioning server 528.

Billing system 522 is for monitoring system usage with respect to variable billing plans and for generating corresponding bills. Additionally, billing system 522 generates fixed price bills for services that are selected by way of CIS 516.

Provisioning server 528 is coupled to communicate with the plurality of provisioning agents 532 and 536. It is understood that only two provisioning agents are shown in FIG. 5 for simplicity. SMI 524 also is coupled to communicate with the plurality of provisioning agents 532 and 536. Provisioning agents 532 and 536 host the actual services such as the virtual servers and web pages that are created for the customer of user terminal 508.

In operation, CIS 516 generates graphical user interface display pages that are produced to user terminal 508 by way of data packet network 504 to enable the customer of user terminal 508 to generate the service request 512. The service request 512 not only defines the specific usage parameters sought by the customer of user terminal 508, but also account and billing information that is requested by CIS 516. CIS 516 communicates with LDAP 520 to provide user profile information thereto and to receive user profile information therefrom whenever a change to a service is being requested.

CIS 516 further communicates with SMI 524 to facilitate the provisioning and creation of the services requested by the customer of user terminal 508. Provisioning server 528 receives control signals from SMI 524 to prompt it to initiate certain service provisioning and processes. Additionally, provisioning server 528 receives service plan information 540 from CIS 516. Accordingly, provisioning server 528 is able to determine the service requirements for the customer of user terminal 508 and to determine which provisioning agent 532 or 536 is best able to satisfy the service requirements.

As a part of determining which provisioning agent 532 or 536 should host the service for user terminal 508, SMI 524 receives usage parameters 544 from each of the provisioning agents 532 and 536. From the usage parameters 544, SMI 524 is able to determine which provisioning agent 532 and 536 has the greatest capacity to perform the hosting or otherwise provide the services for user terminal 508. In the present example, it is assumed that provisioning server 528 selects provisioning agent 532 to provide the services for user terminal 508. Accordingly, provisioning agent 532 generates the web pages or accounts as necessary that are accessible through data packet network 504 by the market users. The general marketplace, of course, includes customers of all types for the services being provided for the service customer of user terminal 508.

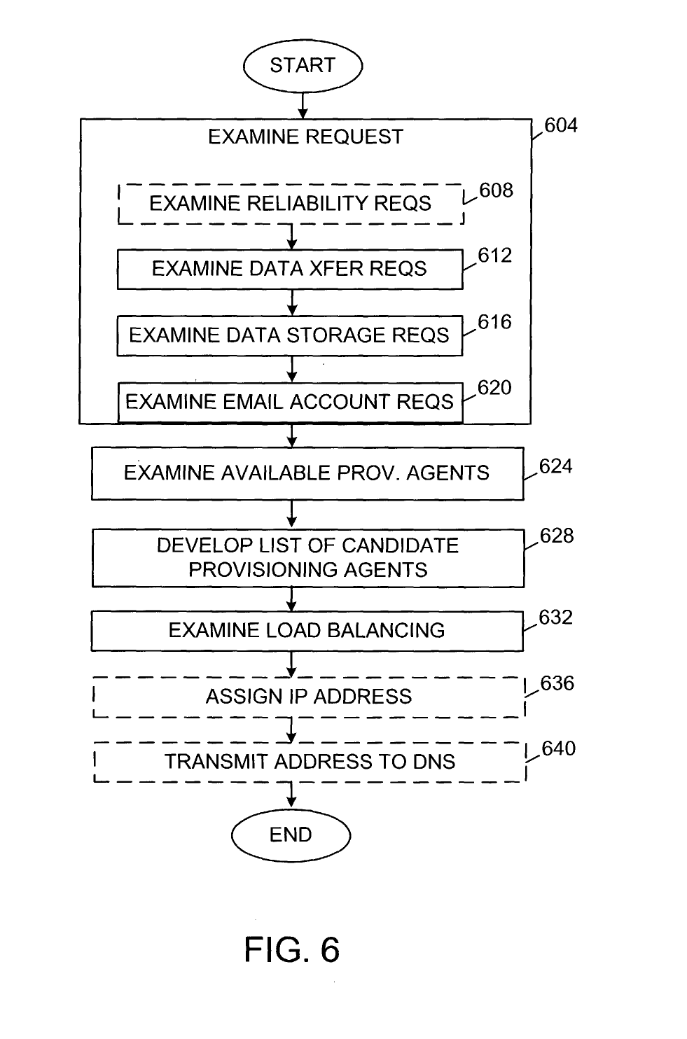

FIG. 6 is a flowchart that illustrates a method for determining and allocating computer resources to provide requested service according to one embodiment of the present invention. Initially, a service request is examined (step 604). The service request will include many different service parameters, as well as account information for the customer making the request. Thus, the subsequent step is to examine reliability requirements, if specified, by the user or customer (step 608). Additionally, the data transfer requirements are examined (step 612), as well as the data storage requirements (step 616) and the number of e-mail accounts (step 620). Other additional user request parameters may also be evaluated and are specifically included as a part of the present invention.

After examining and determining each of the requirements made by the customer, the next step includes evaluating the available servers or provisioning agents that may be used to establish the service required by the customer (step 624). For example, of the many different provisioning agents that could provide the requested services, some may not have the reliability that is requested by the customer. For example, the customer may specifically want a certain class of equipment or device to provide the hosting for reliability purposes. Additionally, other parameters such as data transfer rates, data storage amounts and number of e-mail accounts may be used to limit the number of available provisioning agents.

From this evaluation of available provisioning agents, a list of potential provisioning agents for providing this service is developed (step 628). After developing a list of available provisioning agents, the next step is to evaluate the load balancing across the network to create a balance load within a defined threshold amount (step 632). For example, to have exact load balancing would be nearly impossible. However, to have load balancing within certain specified parameters is quite achievable according to the threshold parameters for balancing. In one embodiment of the present invention, it is a goal that every server be utilized within 5% of an average utilization amount. Accordingly, if one server or provisioning agent lags behind the average utilization amount, then that provisioning agent would be a strong candidate for providing the desired or requested services.

In one embodiment of the invention, the load balancing is monitored in terms of actual usage of the system. In another embodiment of the invention, what is examined is the amount of available resources on a per-server basis. Accordingly, a server or provisioning agent having the most resources available that otherwise satisfies all other requirements might be selected for providing the requested service.

Once the server or provisioning agent is identified for providing the service, then an IP address is assigned to that provisioning agent (step 636). The IP address is for a virtual server although it is transparent to external systems that the server is a virtual server. Thereafter, the IP address is transmitted to a DNS where it is mapped to the subnet or network containing an actual server or provisioning agent (step 640).

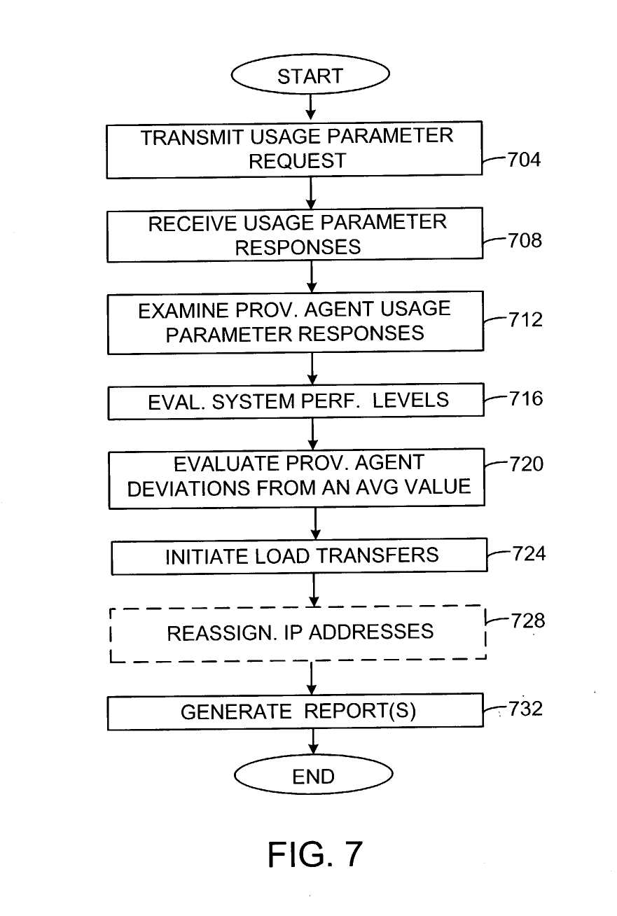

FIG. 7 is a flowchart that illustrates one method according to the present invention for load balancing. More particularly, the method of FIG. 7 relates not only to the assignment of dedicated virtual servers to an actual server, but also to the reassignment of virtual servers from an actual server to another so as to achieve a balanced network operating at efficient levels. Initially, a service manager integrator generates a request to a plurality of provisioning agents to receive usage parameters (step 704). In an alternate embodiment of the invention, step 704 does not exist because each of the provisioning agents merely generates the usage parameters on a periodic basis to the SMI. For the present embodiment, however, the SMI generates the usage parameter requests. Thereafter, the SMI receives the usage parameter responses from each of the provisioning agents (step 708). Thereafter, the SMI produces usage reports or messages to the provisioning agent regarding network conditions and statistics. The provisioning server examines the server usage parameters (step 712) and evaluates system usage levels (step 716) to evaluate load balancing. Additionally, the provisioning server determines which actual servers or provisioning agents have usage levels that exceed a defined threshold (step 720). For example, if a provisioning agent has indicated through its usage parameters that its available resources are much lower than the available resources on average of other provisioning agents, and that difference exceeds a specified threshold, then the provisioning server will determine to reassign at least one virtual server from that provisioning agent to one that better has the capacity to host the virtual server. Thereafter, the provisioning server initiates the load change from one provisioning agent to another (step 724). Optionally, and if necessary, IP addresses are reassigned (for example, if a software load is being transferred to another network) and a DNS is updated (step 728). Thereafter, a report of the reassigned accounts is generated to reflect all load balancing activities (step 732).

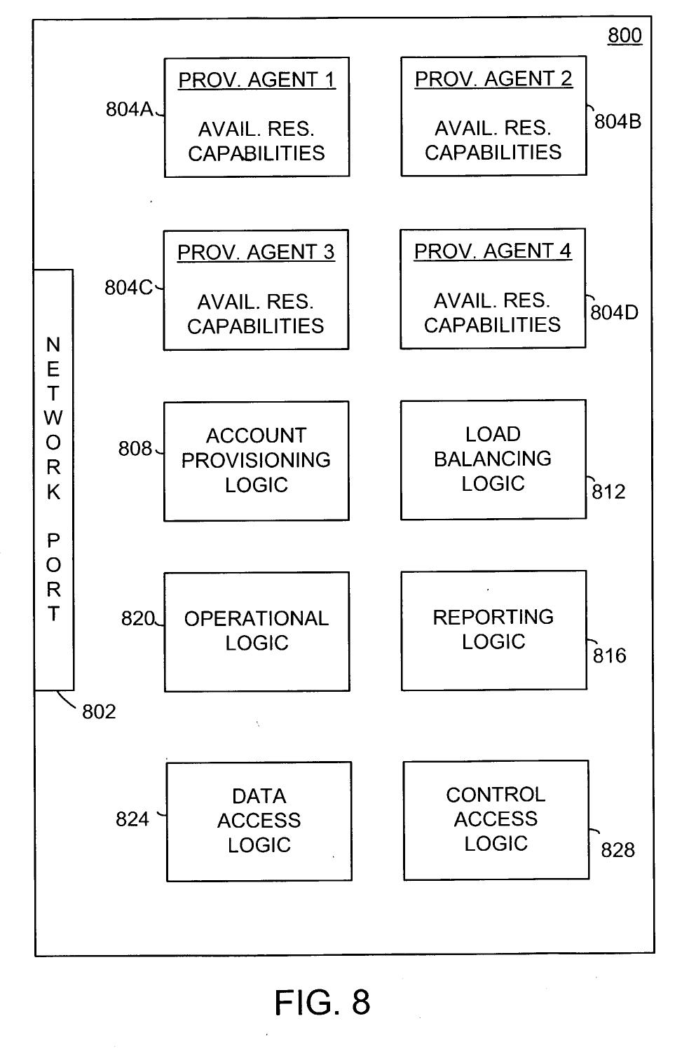

FIG. 8 is a functional block diagram of a provisioning server formed according to one embodiment of the present invention. As may be seen, a provisioning server 800 includes a plurality of modules that perform different tasks. Each of the modules of FIG. 8 may be formed either in hardware, for example, in application-specific integrated circuit logic implementation, or in field programmable gate array logic implementation, or in a combination thereof. Additionally, the modules of FIG. 8 may be created by processor-driven software as was described with respect to FIG. 4.

The provisioning server 800 includes four modules that each are assigned to monitor the available resources and capabilities of a corresponding provisioning agent. For example, the network to which provisioning server 800 is used includes four provisioning agents. Each provisioning agent initially has a set of capabilities and available resources. They may be the same or different from one another. As virtual servers are created and assigned to each of the provisioning agents (not shown) by provisioning server 800, the remaining resources that are available and their capabilities are monitored for the corresponding provisioning agent. Thus, as may be seen, provisioning agent 804A tracks the available resources and capabilities for a first provisioning agent. Similarly, provisioning agents 804B, 804C and 804D monitor the same for their respective provisioning agents 2-4. Each of the modules 804A-804D receives network condition and statistics information from an external service manager integrator.

Besides these modules, provisioning server 800 includes account provisioning logic module 808. Account provisioning logic 808 is for establishing an account and maintaining account records. For example, provisioning server 800 receives service requests for a given account from an external system (e.g., a central integration server). The account provisioning logic therefore serves to create the service as is descried herein, and to generate any signaling that is required in support thereof. For example, if a need exists to generate an update signal regarding the account either to the central integration server or to a billing system, account provisioning logic 808 includes the logic to perform such task.

Additionally, provisioning server 800 includes a load balancing logic module 812. Load balancing logic module 812 performs load balancing as has been described and is described herein. Generally, however, load balancing is performed for any one of a plurality of reasons. One reason that, for example, a virtual server might be removed from one provisioning agent to another to balance the loads is that the remaining capacity of the first provisioning agent is significantly lower than the average remaining capacity for the other provisioning agents.

As a part of the account provisioning logic 808, one parameter that is received and monitored is a threshold value that prompts the load balancing steps to occur among the provisioning agents. Stated differently, the user establishes a threshold that prompts provisioning server 800 to cause a provisioning agent to transmit some of its load, for example, a virtual server, to another provisioning agent as specified by provisioning server 800.

Another reason that load balancing logic might re-provision virtual servers from one provisioning agent to another is maintenance or failure. In the case where a provisioning agent needs to be taken out of service or has gone out of service, the load balancing logic module 812 would redistribute the virtual servers within provisioning agent 1, for example, to provisioning agents 804B, 804C and 804D (provisioning agents 2, 3 and 4) in a manner where the loads remain as balanced as possible.

Provisioning server 800 further includes operational logic module 820 that defines other operational logic of the provisioning server. The types of logic defined herein depend on the complexity of the server and other routine operational processes that it must employ. For example, operational logic module 820 includes communication protocol information for communicating with external devices through network port 802.

Provisioning server 800 further includes a reporting logic module 816 that generates system reports to users according to the user level and the type of user report specified for the given user. Provisioning server 800 also includes data access logic module 824 and control access logic module 828. Data access and control logic modules 824 and 828 work jointly to allow access by others to access data and to control the provisioning agents and to modify reporting functions and other similar functions.

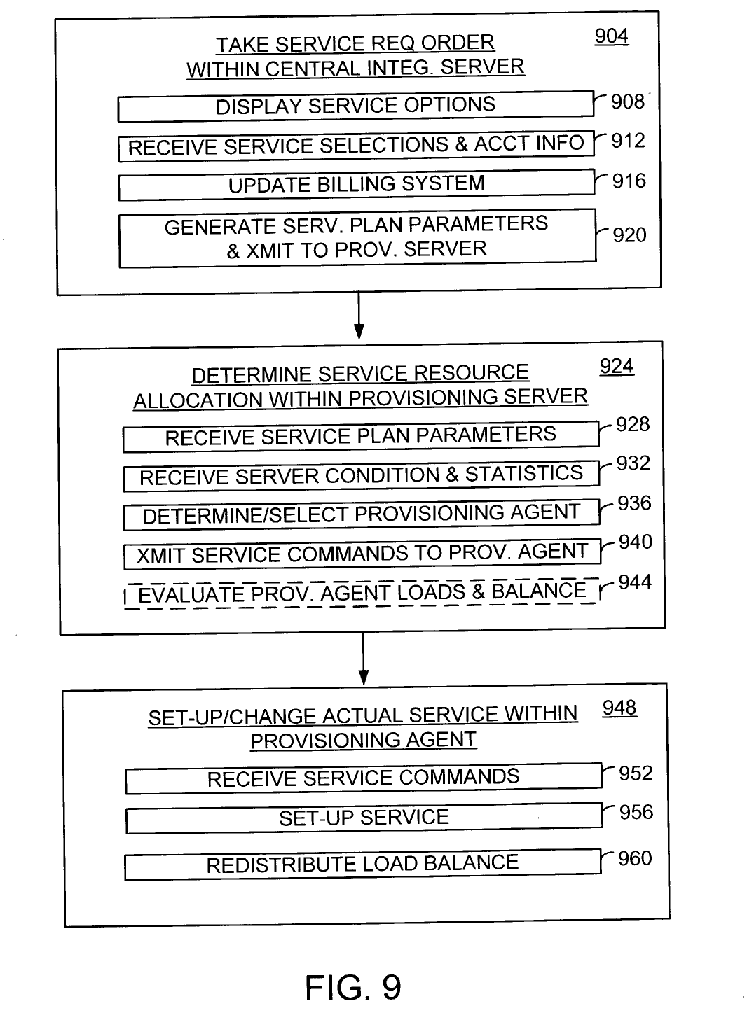

FIG. 9 is a flowchart that illustrates a method for automatically provisioning services for a user according to one embodiment of the present invention. Referring to FIG. 9, three major steps may be observed. Initially, a central integration server, in one embodiment of the present invention, takes service request orders for processing (step 904). This step of taking service request orders includes the sub-steps of displaying service options (step 908), receiving service selections and account information (step 912), updating a billing system (step 916) and generating service plan parameters that are to be transmitted to a provisioning server (step 920).

The step of displaying service options, in one embodiment of the present invention, includes generating graphical user interfaced (GUI) display signals that are transmitted via a network, typically the World Wide Web, to a user terminal for display thereon. The GUI displays further include interactive windows and “buttons” to enable the user of the user terminal receiving the GUI signals to enter data and to select service options. Thus, in addition to displaying the GUI generated service options, the invention includes receiving the user service selections and entered account information. According to the responses, a billing system must also be updated. Updating the billing system, as specified in step 916 includes either generating account information to a billing system so that a new account may be set up for new services or, alternatively, generating mere updates to an existing account. Finally, as a part of setting up the service and accounts, the service plan parameters are transmitted to a provisioning server for actual activation.

Thus, the next major step within the process of FIG. 9 is one that is performed by the provisioning server. A provisioning server initially determines service resource allocations and then effectuates the service activation (step 924). Step 924 includes receiving service plan parameters from a central integration server (step 928). It also includes receiving server condition and statistics information from an external device that monitors the same (step 932). In one embodiment of the present invention, the server monitors conditions and statistics are received from an SMI, for example, SMI 524 of FIG. 5. Based upon server conditions and statistics for a plurality of servers, the provisioning server determines and selects an appropriate provisioning agent for the service that is being created and that is defined by the service plan parameters (step 936). Once the provisioning agent has been selected, the provisioning server transmits service commands to the provisioning agent to prompt it to actually establish the service (step 940). Typically this includes establishing a virtual server for the requested service. As a part of step 924, the provisioning agent receives service instructions in a manner that leads to balanced loads within the network. The overall balance is maintained and monitored as described herein (step 944). Step 944 is shown in dashed lines here to indicate that it is an optional step, meaning that it is performed on occasion or periodically and not continuously. In an alternate embodiment of the invention, however, the process of evaluating provisioning agent loads and network balance is performed continuously.

The final major step of the present invention includes setting up or changing actual service within a provisioning agent (step 948). Step 948, therefore, includes receiving service commands from a provisioning server (step 952), setting up or changing the service in a corresponding manner (step 956) and, when load balancing requires, transmitting or receiving settings to or from another provisioning agent to effectuate load balancing and redistribution (step 960).

While the invention is susceptible to various modifications and alternative forms, specific embodiments thereof have been shown by way of example in the drawings and detailed description. It should be understood, however, that the drawings and detailed description thereto are not intended to limit the invention to the particular form disclosed, but on the contrary, the invention is to cover all modifications, equivalents and alternatives falling within the spirit and scope of the present invention as defined by the claims. As may be seen, the described embodiments may be modified in many different ways without departing from the scope or teachings of the invention.

1. A provisioning server, comprising:
a processor;
a bus; and
a memory, which memory defines computer instructions for execution by the processor that define operational logic for:
receiving network data from a service manager integrator;
evaluating load distribution among a plurality of provisioning agents; and
issuing commands to one or more provisioning agents to prompt one or more provisioning agents to transfer some of the software being hosted thereon to another provisioning agent.

2. The provisioning server of claim 1 further including computer instructions that define logic for evaluating a parameter received in service plan information, which parameter is used for determining when load balancing should occur and, more specifically, when the first provisioning agent should transfer some of its software load to a second provisioning agent.

3. A provisioning server, comprising:
a processor;
a bus coupled to the processor;
a memory coupled to the bus, the memory for storing computer instructions that are transmitted to the processor over the bus for execution, the computer instructions defining operational logic that:
prompts the provisioning server to select a provisioning agent for providing a requested service; and
prompts the provisioning server to reallocate a service from a first provisioning agent to a second provisioning agent to improve network loading.

4. The provisioning server of claim 1 wherein the provisioning server further includes computer instructions that define logic for evaluating received service plan information to determine when load balancing should be performed.

5. The provisioning server of claim 1 further comprising computer instructions that prompt the provisioning server to evaluate remaining capacity for a plurality of provisioning servers.

6. The provisioning server of claim 1 further including computer instructions to prompt it to determine whether a provisioning agent's remaining capacities are within a threshold difference between it and an average remaining capacity value for a plurality of provisioning servers.

7. The provisioning server of claim 1 further including computer instructions that define logic to prompt it to communicate with a service manager integrator.

8. The provisioning server of claim 5 wherein the provisioning server is formed to receive and interpret provisioning agent condition and statistics information as a part of determining loading for the provisioning agents.

9. The provisioning server of claim 1 formed to receive a performance specification for a service in a service plan and also formed to initiate load balancing transfers to satisfy the received performance specifications.

10. A method for load balancing, comprising:
receiving usage parameter information for a plurality of provisioning agents;
examining the usage parameters that were received;
evaluating system usage levels; and
performing load balancing for the plurality of provisioning agents.

11. The method of claim 10 further comprising the step of determining the remaining capacity for each of the provisioning agents.

12. The method of claim 11 further including the step of determining an average remaining capacity value.

13. The method of claim 12 wherein the average remaining capacity value is compared to the actual remaining capacity value for each of the plurality of provisioning agents.

14. The method of claim 12 further including the step of determining whether, for each of the provisioning agents, whether the amount of remaining capacity exceeds a threshold value in comparison to an average remaining capacity value for the plurality of provisioning agents.

15. The method of claim 14 wherein a load transfer is initiated from a first provisioning agent to a second provisioning agent whenever the remaining capacity exceeds the specified threshold in comparison to the average remaining capacities for the plurality of provisioning agents.

16. The method of claim 15 comprising the step of generating reports reflecting the load transfer from the first provisioning agent to the second provisioning agent.

17. The method of claim 16 wherein the step of generating reports comprises generating specific alerts to a specified user.

18. The method of claim 10 wherein load balancing determinations include analyzing the memory usage of a provisioning agent.

19. The method of claim 10 wherein load balancing determinations include analyzing the bandwidth of a provisioning agent.

20. The method of claim 10 wherein load balancing determinations include analyzing the throughput of a provisioning agent.

21. The method of claim 10 wherein load balancing determinations include analyzing the response time of a provisioning agent.

22. The method of claim 10 wherein load balancing determinations include analyzing the performance of a provisioning agent.
